(19) United States
(12) Patent Application Publication
(10) Pub. No.: US 2022/0308808 A1
(43) Pub. Date: Sep. 29, 2022

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Tomohiro KICHIKAWA, Kanagawa (JP)

(73) Assignee: FUJIFILM Business Innovation Corp., Tokyo (JP)

(21) Appl. No.: 17/392,433

(22) Filed: Aug. 3, 2021

(30) Foreign Application Priority Data
Mar. 24, 2021 (JP) 2021-049509

(51) Int. Cl. G06F 3/12; G06F 21/62

(52) U.S. Cl. CPC G06F 3/1222; G06F 21/6209; G06F 3/1238

(57) ABSTRACT

An information processing apparatus includes: a processor configured to: receive information about a printing device instructed by a user to print a document; when the information about the printing device is information about a printing device other than a predetermined printing device, acquire information about an access right of the user to the document; and determine a print mode of the document according to the information about the access right.

### CROSS-REFERENCE TO RELATED APPLICATIONS

This application is based on and claims priority under 35 USC 119 from Japanese Patent Application No. 2021-049509 filed Mar. 24, 2021.

### BACKGROUND

### (i) Technical Field

The present disclosure relates to an information processing apparatus, an information processing method, and a non-transitory computer readable medium.

### (ii) Related Art

JP-A-2011-123578 considers a problem in the carry-out control of a printed matter that is performed through only an operation log, in which it is not possible to clearly determine the permission/non-permission of the carry-out of an individual printed matter, and it is not possible to control the concrete action of carrying out the printed matter. Thus, JP-A-2011-123578 discloses a network system in which the permission/non-permission of the carry-out of the printed matter is registered for every printed matter, and who is able to carry out the printed matter is registered in the form that all pages of the printed matter are identified. In the network system, when the printed matter is carried to the outside of a management division, a person who is trying to carry out the printed matter is authenticated and confirmed about all the pages of the printed matter based on the registration information, and the leaving of the person who is trying to carry out the printed matter is controlled according to the authentication/confirmation result, so that the carry-out of the individual printed matter is closely and physically controllable.

Japanese Patent No. 6432321 discloses an information processing system that includes a server and a permission/non-permission determination device that determines the permission/non-permission of the carry-out of a printed matter from a predetermined area. The server includes a storage that stores a first image used when an image output apparatus outputs the printed matter, in association with attribute information including the permission/non-permission of the carry-out of the printed matter to the outside of the predetermined area, and an image receiver that receives a second image which is at least a part of the printed matter. The permission/non-permission determination device includes a reader that reads the printed matter and acquires the second image, and a transmitter that transmits the second image acquired by the reader to the server. The server searches the storage for the first image that matches the second image. When the first image that matches the second image is not present, the server determines that something is written in the printed matter, and then determines not to permit the carry-out of the printed matter. When the first image that matches the second image is present, and the attribute information corresponding to the first image represents the non-permission of the carry-out, the server determines not to permit the carry-out of the printed matter. When the first image that matches the second image is present, and the attribute information corresponding to the first image represents the permission of the carry-out, the server determines to permit the carry-out of the printed matter.

JP-A-2008-046886 considers preventing the illegal taking of a confidential document while eliminating the inconvenience. According to the disclosure, a host-side device uses a tagged paper for a confidential output job, and sets a rule on taking of documents and notifies an image output terminal of the rule on taking of documents. For the confidential output job, a printer notifies a monitoring mechanism side of an identifier of the tagged paper and the rule on taking of documents associated with each other, and executes a printing process using the tagged paper. The monitoring mechanism side executes user authentication processing and gate opening/closing control processing such that the identifier and the rule on taking of documents are registered in the database, the identifier is read when the output result passes through a gate and the rule on taking of documents is specified through a collation with the database, and then, an authorized user is permitted to take the output result of the security target document according to the rule on taking of documents and an unauthorized user is prohibited from taking the output result of the security target document.

### SUMMARY

If a system prints a document without referring to a printing device during printing of the document, when a printing device other than a predetermined printing device prints the document, it is not possible to set a print mode different from a print mode in which the predetermined printing device prints the document. Therefore, aspects of non-limiting embodiments of the present disclosure relate to an information processing apparatus, an information processing method, and a non-transitory computer readable medium that can determine a print mode of a document when a printing device other than a predetermined printing device prints the document, unlike in a case where the document is printed without referring to the printing device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a processor configured to: receive information about a printing device instructed by a user to print a document; when the information about the printing device is information about a printing device other than a predetermined printing device, acquire information about an access right of the user to the document; and determine a print mode of the document according to the information about the access right.

### BRIEF DESCRIPTION OF THE DRAWINGS

Exemplary embodiment(s) of the present disclosure will be described in detail based on the following figures, wherein:

FIG. 1 is a conceptual module configuration diagram of a configuration example of an exemplary embodiment;

FIG. 2 is a view illustrating an example of a system configuration using the exemplary embodiment;

FIG. 3 is a view illustrating a specific example of a system configuration using the exemplary embodiment;

FIG. 4 is a flowchart illustrating an example of processing by the exemplary embodiment;

FIG. 5 is a view illustrating an example of a data structure of a user management table;

FIG. 6 is a view illustrating an example of a data structure of a risk level determination table;

FIG. 7 is a view illustrating an example of a hierarchical structure of folders;

FIG. 8 is a view illustrating an example of a data structure of a pre-approval table;

FIG. 9 is a view illustrating an example of a data structure of a taking-of-documents management table;

FIG. 10 is a view illustrating an example of a data structure of a management scope table;

FIGS. 11A and 11B are views illustrating an example of printing according to the exemplary embodiment; and

FIG. 12 is a view illustrating an example of processing by the exemplary embodiment (an example of a printability determination result).

### DETAILED DESCRIPTION

Hereinafter, an example of an exemplary embodiment highly suitable for implementing the present disclosure will be described with reference to drawings.

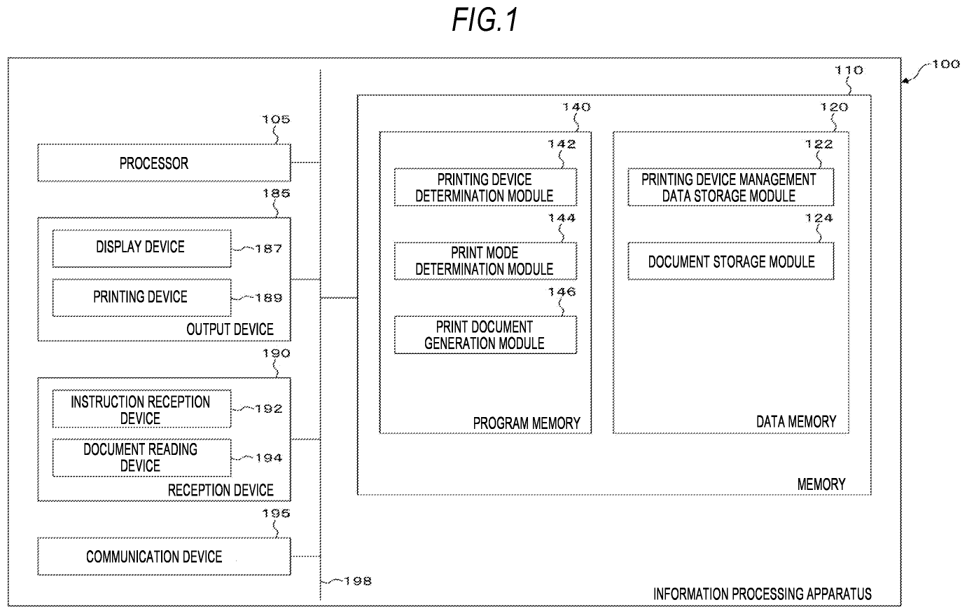

FIG. 1 illustrates a conceptual module configuration diagram of a configuration example of the exemplary embodiment.

Meanwhile, a module generally refers to a logically separable component such as software (including a computer program as an interpretation of “software”) or hardware. Accordingly, the module in the exemplary embodiment refers to not only a module in the computer program, but also a module in a hardware configuration. Therefore, the exemplary embodiment also describes a computer program, a system, and a method which cause a computer to function as the module (for example, a program for causing a computer to execute each procedure, a program for causing a computer to function as each unit, and a program for causing a computer to implement each function). Meanwhile, for the convenience of descriptions, the expressions “store”, “caused to store”, and equivalent expressions thereto will be used, and when the exemplary embodiment is a computer program, the expressions indicate storing data or the like in a storage device or performing a control to store data or the like in a storage device. In addition, one module may correspond to one function. Meanwhile, in implementation, one module may be implemented by one program, plural modules may be implemented by one program, or conversely, one module may be implemented by plural programs. Further, plural modules may be executed by one computer, or one module may be executed by plural computers in a distributed or parallel environment. In addition, one module may include another module. Hereinafter, the term “connection” is used for a case of not only a physical connection, but also a logical connection (for example, a data exchange, an instruction, a reference relationship between data, and a login). The term “predetermined” indicates being determined prior to a target process, and includes the meaning of being determined according to a situation/state at or until a specific time point prior to the target process not only before a process by the present exemplary embodiment is started, but also even after the process by the present exemplary embodiment is started. When there are plural “predetermined values”, the values may be different from each other, or two or more values (including any values) of the plural predetermined values may be the same. The description “when it is A, B is performed” indicates that “it is determined whether it is A or not, and when it is determined that it is A, B is performed”, except for a case where the determination as to whether it is A or not is unnecessary. In addition, when items are enumerated like “A, B, and C”, the enumeration is merely exemplary, and includes a case where only one (for example, only A) of the items is selected, unless otherwise specified.

In addition, a system or device includes not only a configuration where plural computers, hardware components, devices and the like are connected via a communication unit such as a network (including a one-to-one correspondence communication connection), but also a configuration implemented by one computer, one hardware component, one device and the like. The terms “device” and “system” are used to have the same meaning. The “system” does not include a system that merely means a social “structure” (that is, a social system) which is an artificial engagement.

In addition, target information is read from a storage device for each process performed by each module, or for each of plural processes performed by a single module. After the process is executed, the process result is written to the storage device. Thus, descriptions regarding the reading from the storage device prior to a process and the writing to the storage device after a process may be omitted.

An information processing apparatus 100 of the exemplary embodiment has a function of determining if a document is printable during teleworking, and managing taking of a printed document. As illustrated in the example of FIG. 1, the information processing apparatus 100 includes at least a processor 105 and a memory 110, and is implemented by a bus 198 that connects the processor 105 and the memory 110 to each other so as to exchange data. Further, the information processing apparatus 100 may include an output device 185, a reception device 190, and a communication device 195. Then, via the bus 198, data exchange is performed among the processor 105, the memory 110, the output device 185, the reception device 190, and the communication device 195.

When a document is printed outside a company (for example, at home) during a work through teleworking, the document enters into a state of “after taken out” at the moment of the printing.

The information processing apparatus 100 determines a printability according to whether a printing device is a device other than a predetermined printing device, and manages taking of information so as to prevent unauthorized taking of information in advance. Meanwhile, the description “whether a printing device is a device other than a predetermined printing device” means “whether the printing device is present in a predetermined location” when a work is performed by teleworking, and corresponds to “according to a printing location”.

Meanwhile, the block diagram illustrated in the example of FIG. 1 also illustrates an example of a hardware configuration of a computer that implements the exemplary embodiment. The hardware configuration of the computer on which a program according to the exemplary embodiment is executed corresponds to a computer illustrated in FIG. 1, specifically, a personal computer, a computer that may function as a server, or the like. As a specific example, the processor 105 is used as a processor, and the memory 110 is used as a storage device.

There may be one processor 105 or plural processors 105. The processor 105 includes, for example, a central processing unit (CPU), a microprocessor or the like. When the plural processors 105 are used, any of forms including a tightly coupled multiprocessor and a loosely coupled multiprocessor may be employed. For example, plural processor cores may be mounted in one processor 105. Further, plural computers may be connected by a communication path to constitute a system that virtually behaves as if it is one computer. As a specific example, as the loosely coupled multiprocessor, a configuration as a cluster system or a computer cluster may be made. The processor 105 executes a program in a program memory 140.

The memory 110 may include, for example, a semiconductor memory inside the processor 105, such as a register or a cache memory, may be a main memory as a main storage device implemented by a random access memory (RAM), a read only memory (ROM) or the like, may be an internal storage device having a function as a persistent storage device, such as an a hard disk drive (HDD) or an solid state drive (SSD), or an external storage device or an auxiliary storage device such as a CD, a DVD, a Blu-ray (registered trademark) disc, a USB memory, or a memory card, or may include a storage device connected via a communication line, such as a server.

The memory 110 includes a data memory 120 that mainly stores data and the program memory 140 that mainly stores a program. Meanwhile, in the data memory 120 and the program memory 140, not only the illustrated information, and module programs, but also a program for booting up the computer, such as an OS, and data such as parameters that suitably change in the module execution may be stored.

The output device 185 includes, for example, a display device 187, a printing device 189 and the like. The display device 187, which is a liquid crystal display, an organic EL display, a three-dimensional display, a projector or the like, displays the result of processing by the processor 105, data within the data memory 120, and the like, as a text, image information, or the like. The printing device 189, which is a printer, a multifunction device or the like, prints the result of processing by the processor 105, data within the data memory 120, and the like. The output device 185 may include a speaker, an actuator that vibrates an apparatus, or the like.

The reception device 190 includes, for example, an instruction reception device 192, a document reading device 194 and the like. The instruction reception device 192, which is a keyboard, a mouse, a microphone, a camera (including a gaze tracking camera or the like) or the like, receives data based on a user operation on the device (including a motion, a voice, a gaze, etc.).

Also, there may be, for example, a touch screen having functions of both the display device 187 and the instruction reception device 192. In this case, even when there are no physical keys for implementing a keyboard function, a keyboard (also so-called a software keyboard, a screen keyboard or the like) may be drawn on the touch screen by software so that the keyboard function may be implemented.

Meanwhile, as a user interface, the display device 187 and the instruction reception device 192 are mainly used.

The document reading device 194, which is a scanner, a camera or the like, receives image data generated when a document is read or an image of a document is captured.

The communication device 195 is a communication line interface such as a network card, which is used for connection to another device via a communication line.

Of the exemplary embodiments, an exemplary embodiment related to a computer program is implemented in the manner that the computer program which is software is read into the program memory 140 which is a hardware component in the present disclosure, and software and hardware resources cooperate with each other. That is, the present exemplary embodiment is specifically implemented in the manner that information processing by software uses hardware resources (including at least the processor 105, and the memory 110, and in some cases, the output device 185, the reception device 190, and the communication device 195), and uses the law of nature as a whole.

Meanwhile, the hardware configuration illustrated in FIG. 1 is merely an example, and the exemplary embodiment is not limited to the configuration illustrated in FIG. 1 as long as the modules described in the exemplary embodiment are executable. For example, a graphics processing unit ((GPU); including general-purpose computing on graphics processing units (GPGPU)) may be used as the processor 105. The execution of some modules may be configured with dedicated hardware (for example, an integrated circuit for a specific use (a specific example includes an application specific integrated circuit (ASIC) or the like) or a reconfigurable integrated circuit (a specific example includes a field-programmable gate array (FPGA) or the like). A mode in which some modules are present in the external system and are connected via a communication line may be employed, and further, plural systems illustrated in FIG. 1 may be connected to each other through a communication line so as to cooperate with each other. In particular, the configuration may be incorporated into a portable information communication device (including a cellular phone, a smartphone, a mobile device, a wearable computer and the like), information appliances, a robot, a copier, a facsimile, a scanner, a printer, a multifunction device (an image processing device having two or more functions of a scanner, a printer, a copier, a facsimile and the like) or the like as well as the personal computer.

The processor 105 is connected to the memory 110, the output device 185, the reception device 190, and the communication device 195 via the bus 198. The processor 105 executes processing according to a program within the program memory 140, that is a computer program that describes an execution sequence of each module. For example, when a user operation is received by the instruction reception device 192, processing by a module corresponding to the operation within the program memory 140 is executed, and the processing result is stored in the data memory 120, is output to the display device 187, or is transmitted to another device through control of the communication device 195.

The memory 110 includes the data memory 120, and the program memory 140, and is connected to the processor 105, the output device 185, the reception device 190, and the communication device 195 via the bus 198.

The data memory 120 includes a printing device management data storage module 122, and a document storage module 124.

The printing device management data storage module 122 stores information for managing a printing device.

The document storage module 124 stores a document, and information about the document. A risk level has been set for the document according to an access right assigned to the document. That is, the information about the document includes the risk level which has been set according to the access right assigned to the document. The “risk level of the document” means that the higher the value of the risk level is, the higher the risk is. That is, the higher the risk level of the document is, the more limited the people who can access the document are. When the risk level of the document is the lowest value (for example, 0), anyone can access the document.

Further, the information about the document includes information about an access right of the user to the document. Then, a risk level for which the user has been approved in advance (pre-approved) may have been set for the user. Meanwhile, the “risk level of the user” means that the higher the value of the risk level is, the higher the risk level of a document accessible by the user is.

The program memory 140 stores a printing device determination module 142, a print mode determination module 144, and a print document generation module 146.

When a user makes an instruction to print a document by a printing device other than the predetermined printing device, the program memory 140 determines a print mode of the document according to the access right of the user to the document.

The printing device determination module 142 receives information about the printing device instructed by the user to print the document, and determines whether the information about the printing device is information about a printing device other than a predetermined printing device. When the received information about the printing device is information about a printing device other than the predetermined printing device, the processing by the print mode determination module 144 is performed. When the received information about the printing device is not information about a printing device other than the predetermined printing device (that is, when the received information about the printing device is information about the predetermined printing device), the processing by the print document generation module 146 is performed.

When the printing device determination module 142 determines that the received information about the printing device is information about a printing device other than the predetermined printing device, the print mode determination module 144 acquires information about the access right of the user to the document, and determines a print mode of the document according to the information about the access right.

Here, “determining a print mode of the document” includes determining whether or not to print the document, and further includes determining whether to print the document with addition of an information image or to print the document as it is without the addition of the information image when the document is printed. Specifically, in some cases, in a printing device other than the predetermined printing device, printing may not be permitted according to the access right of the user to the document. Even when the printing is permitted, the document may be printed with addition of an information image, or the document may be printed without the addition of an information image (the original document may be printed as it is).

Meanwhile, the information image refers to an image code that is systematically generated in order to represent electronic data in a machine-readable manner, and specifically includes a one-dimensional barcode, a two-dimensional code and the like. In particular, a QR code (Quick Response code: registered trademark) has recently been used as the two-dimensional code, and the exemplary embodiment also describes the QR code as an example. The information image is embedded with information indicating that the document has been taken of the company (which is information for managing taking of the document, and which corresponds to a “Print ID” which will be described later as a specific example). The information image may be further embedded with information about a printing location, information about a user who has performed printing, printing date and time (year, month, day, hour, min, sec, millisecond or less, or a combination thereof may be used) and others.

The print mode determination module 144 may compare the risk level of the document and the risk level of the user with each other, to determine the print mode of the document.

The risk level of the document may have been determined according to the number of organizations to which users having access rights to the document belong. The organizations include groups, departments, sections, and the like. Hereinafter, groups will be described as an example of the organizations.

Further, when the risk level of the document is equal to or less than the risk level of the user, the print mode determination module 144 may determine the print mode of the document. In this case, the determination of the print mode indicates the determination as to whether or not to add the information image, in a case where the document can be printed.

Further, the risk level of the document may be determined according to whether users having access rights to the document are specified persons. Here, the phrase “the users are specified persons” indicates that setting of an access right to the document is not setting of an access right to a group ID to which the users belong, but setting of an access right to user IDs of the users.

Further, when the risk level of the document is equal to or less than the risk level of the user, the print mode determination module 144 may determine the print mode of the document. In this case, the determination of the print mode indicates the determination as to whether or not to add the information image, in a case where the document can be printed.

The risk level may have been set for the document according to the access right assigned to the document.

Then, the print mode determination module 144 may determine the print mode according to the risk level of the document. Specifically, the pre-approved risk level of the user is compared to the risk level of the document. When the risk level of the document is equal to or less than the risk level of the user, the document can be printed, and when the risk level of the document is included in a management scope, printing is performed with addition of an information image. When the risk level of the document is higher than the risk level of the user, the document cannot be printed. Then, when the risk level of the document is not included in the management scope, printing is performed without addition of the information image.

For each of folders, the print mode may be determined according to a risk level.

Then, when the risk level of the document is included in the risk levels determined for a folder to which the document belongs, the print mode determination module 144 may print information indicating that the document has been taken out of an organization to which the user belongs, on the document as the print mode.

Here, “information indicating that the document has been taken out of an organization to which the user belongs” may be simply, for example, information indicating the carry-out from the company, and may include information for identifying the document, information indicating the user who performed printing, date/time when printing was performed and the like.

As a specific form of the print mode, for example, an information image such as a barcode, or a QR code may be used.

The predetermined printing device may be specified by information for identifying the printing device, a location where the printing device is provided, or a communication line to which the printing device is connected.

Then, the print mode determination module 144 may perform processing of determining the print mode of the document when the printing device trying to print the document is not the predetermined printing device. Here, when information for identifying the printing device (hereinafter, also referred to as identification information) is used, “when the printing device is not the predetermined printing device” refers to a case where identification information of a target printing device is identification information other than identification information of the predetermined printing device. When a location where the printing device is provided is used, “when the printing device is not the predetermined printing device” refers to a case where a location where a target printing device is provided is a location other than a predetermined location (for example, a company). When a communication line to which the printing device is connected is used, “when the printing device is not the predetermined printing device” refers to a case where a communication line to which a target printing device is connected is a communication line other than a predetermined communication line (for example, a communication line for internal use of a company).

The print document generation module 146 generates data for printing the document according to the mode determined by the print mode determination module 144. The data for printing the document is data that can be printed by the target printing device, and includes, for example, portable document format (PDF) data, bitmap data and the like. Meanwhile, as described above, print data to be generated includes a case of print data of the document to which an information image is added and a case of print data of the document to which an information image is not added.

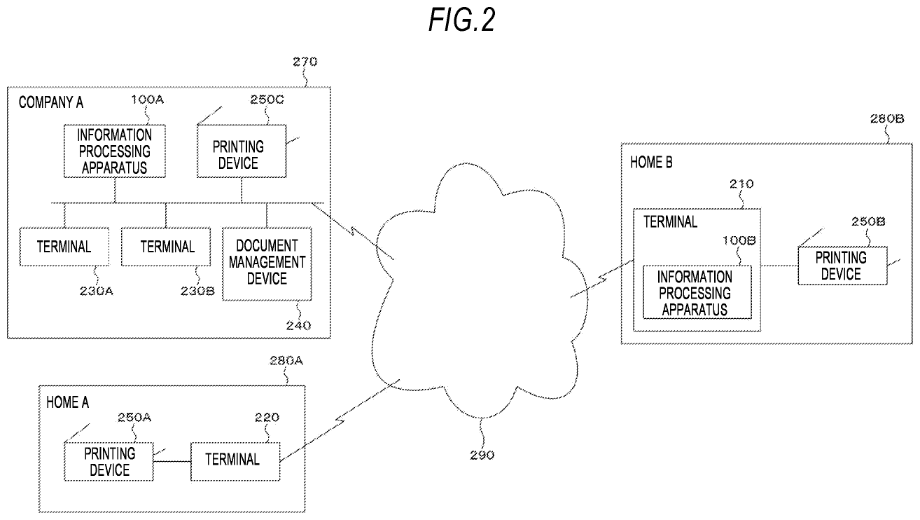

FIG. 2 is a view illustrating an example of a system configuration using the exemplary embodiment.

In a company A 270, an information processing apparatus 100A, a terminal 230A, a terminal 230B, a document management device 240, and a printing device 250C are provided, and are connected to each other via a communication line such as an intranet.

In a home 280A, a terminal 220 and a printing device 250A are provided.

In a home 280B, a terminal 210 and a printing device 250B are provided.

The information processing apparatus 100A, the terminal 230A, the terminal 230B, the document management device 240, and the printing device 250C, within the company A 270, the terminal 220 within the home 280A, and the terminal 210 within the home 280B are connected to each other via a communication line 290. The communication line 290 may be wireless, wired, or a combination thereof, and may be, for example, the Internet as a communication infrastructure. The functions of the information processing apparatus 100 may be implemented as a cloud service.

The terminal 210 causes the printing device 250B to print a document under a control by an information processing apparatus 100B.

The terminal 220 communicates with the information processing apparatus 100A, and causes the printing device 250A to print a document under a control by the information processing apparatus 100A.

The printing device 250A and the printing device 250B are examples in a “case where information about a printing device is information about a printing device other than a predetermined printing device”. That is, this is because the printing device 250A, and the printing device 250B are provided at the home 280A and the home 280B which are locations other than the company A 270.

The printing device 250C is an example in a “case where information about a printing device is information about a predetermined printing device”. That is, this is because the printing device 250C is provided within the company A 270.

For a document to be printed by the printing device 250A or 250B, it is determined whether to print the document, and, when it is determined to print the document, it is determined whether to print an information image, according to the access right of a user (who uses the terminal 210 or 220) to the document.

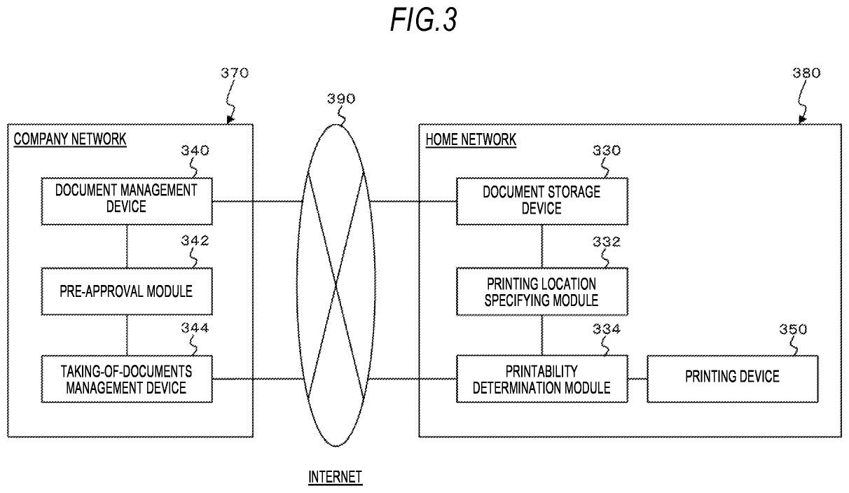

FIG. 3 is a view illustrating a specific example of a system configuration using the exemplary embodiment.

A company network 370 includes a document management device 340, a pre-approval module 342, and a taking-of-documents management device 344 which are connected to each other via a communication line such as an intranet.

The document management device 340 is connected to the pre-approval module 342, and is connected to a document storage device 330 in a home network 380 via the Internet 390. The document management device 340 may manage documents in a hierarchical structure, and may set access rights to folders or files. The access right may include not only an operation right (writing, reading or the like) for each group or user, but also a right of disclosure on the Internet or the like.

The pre-approval module 342 is connected to the document management device 340 and the taking-of-documents management device 344. The pre-approval module 342 may pre-approve a folder or a document of the document management device 340, for each group or user, according to the operation of an approver (a risk owner) for taking of documents. The pre-approval includes whether a document is printable outside the company, whether to attach an information image when printing the document outside the company is permitted, and the like. The pre-approval granted for a folder of the document management device 340 may be recursively applied. Here, “recursively” indicates that the pre-approval granted for the folder is identically applied to folders or documents under the folder. Further, a risk level may be automatically determined by using the access right of the document within the document management device 340, and it may be determined whether to pre-approve each risk level.

The taking-of-documents management device 344 is connected to the pre-approval module 342, and is further connected to a printability determination module 334 in the home network 380 via the Internet 390. The taking-of-documents management device 344 may issue an identifier for a document which is an object the taking of which is managed, by the printability determination module 334, and may manage a taking status (from printing to the end of use) based on printing information. The taking-of-documents management device 344 may check the contents of the document that is taken out in cooperation with the document management device 340.

The home network 380 includes the document storage device 330, a printing location specifying module 332, the printability determination module 334, and a printing device 350 which are connected to each other via a communication line such as Wi-Fi.

The document storage device 330 is connected to the printing location specifying module 332, and is further connected to the document management device 340 in the company network 370 via the Internet 390. The document storage device 330 is, for example, a personal computer or a mobile information communication device. The document storage device 330 may download any folder or document from the document management device 340 through connection from the home network 380 to the company network 370, and store the document in association with an access right and pre-approval information (meta information). Meanwhile, the document within the document storage device 330 may be transmitted in advance through the company network 370. Meanwhile, the document storage device 330 may include the printing location specifying module 332 and the printability determination module 334. That is, when the document storage device 330 includes the printing location specifying module 332 and the printability determination module 334, the configuration is the same as that of the terminal 210 illustrated in the example of FIG. 2, in which the information processing apparatus 100 is incorporated.

The printing location specifying module 332 is connected to the document storage device 330 and the printability determination module 334. The printing location specifying module 332 specifies whether a printing location is a company or a location outside a company (here, home), based on information for identifying the printing device 350, a location where the printing device 350 is provided, or information of a communication line to which the printing device 350 is connected.

The printability determination module 334 is connected to the printing location specifying module 332 and the printing device 350, and is further connected to the taking-of-documents management device 344 in the company network 370 via the Internet 390. The printability determination module 334 determines whether the document can be printed, from a combination of an access right, a pre-approval, and printing location information. In the case of printing, whether the document is an object the taking of which is managed is determined. Then, when the document is the object the taking of which is managed, an identifier may be issued to the taking-of-documents management device 344, and the printing device 350 may be instructed to perform printing with addition of an information image (a QR code, etc.) in which the identifier is incorporated.

The printing device 350 is connected to the printability determination module 334. The printing device 350 may print the document. Further, the printing device 350 may print the document while adding the information image to a header portion, a footer portion or the like of the document.

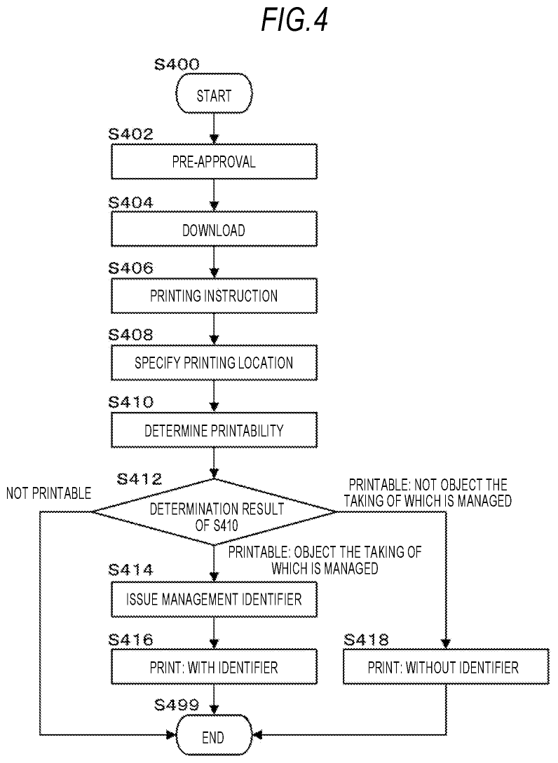

FIG. 4 is a flowchart illustrating an example of processing by the exemplary embodiment.

In step S402, a pre-approval is performed. An approver pre-approves each folder level of the document management device 340. The pre-approval result is recorded in, for example, a pre-approval table 800.

Groups and users of the document management device 340 are defined in, for example, a user management table 500.

The “access right-based risk level determination” is carried out (an access right-based risk level is determined) based on a combination of the user management table 500 and a risk level determination table 600.

In the pre-approval, the approver specifies, for each combination of a folder and a user, the maximum risk level at which the user is permitted to print. Accordingly, up to the specified risk level, the user can perform printing.

The approver is able to determine a management scope for each combination of a folder and a risk level, and the management scope is recorded in, for example, a management scope table 1000.

In step S404, a document is downloaded.

The user can download a document that he/she wants to use from the document management device 340 to the document storage device 330, regardless of a company or home. The downloaded document is given meta information inherited from the folder, that is, meta information of the “access right-based risk level (an access right-based risk level determination column 608 of the risk level determination table 600)”, the pre-approval table 800, and the management scope table 1000.

In step S406, a printing instruction is made.

The user instructs the printing device 350 connected to a communication line to perform printing.

In step S408, a printing location is specified.

When a printing location is specified to be outside a company (home), based on information for identifying the printing device 350, a location where the printing device 350 is provided, the communication line to which the printing device 350 is connected, and the like, a printability is determined. Meanwhile, printing devices provided within a company are managed. That is, when there is a table that stores a list of information for identifying printing devices provided in the company and information for identifying the printing device 350 is not present in the table, it is determined that the printing device 350 is provided outside the company.

In step S410, a printability is determined.

The printability is determined based on the combination of the “access right-based risk level”, the pre-approval table 800, and the management scope table 1000.

When the risk level of a target document (or a folder in which the target document is stored) exceeds the pre-approved risk level, it is determined that the document is not printable.

Then, when the target document (or a folder in which the target document is stored) is not pre-approved, it is determined that the document is not printable.

Then, in a case in which it is not determined that the document is not printable (that is, it is determined that the document is printable), when the “access right-based risk level” falls within a scope specified in the management scope table 1000, it is determined that the document is “printable: an object the taking of which is managed”, and when the “access right-based risk level” does not fall within the scope specified in the management scope table 1000, it is determined that the document is “printable: not an object the taking of which is managed”.

In step S412, the determination result of step S410 is determined. When the document is not printable, the process is ended (step S499). When the document is “printable: an object the taking of which is managed”, the process proceeds to step S414. When the document is “printable: not an object the taking of which is managed”, the process proceeds to step S418.

In step S414, a management identifier is issued.

When the document is printable and is the object the taking of which is managed, the taking-of-documents management device 344 issues an identifier, and records the identifier in a taking-of-documents management table 900 together with the number of printed copies.

In step S416, the document is printed with the identifier.

The printing device 350 prints the document with adding the identifier (a QR code, etc.) to a header or the like of the document.

In step S418, the document is printed without an identifier.

When the document is printable but is not an object the taking of which is managed, the document is not recorded in the taking-of-documents management device 344. The printing device 350 prints the document without adding an identifier (a QR code, etc.) to the document.

FIG. 5 is a view illustrating an example of a data structure of the user management table 500. The user management table 500 is stored in the document management device 340.

The user management table 500 includes a Group ID column 502, a User ID column 504, and a remarks column 506. In the exemplary embodiment, the Group ID column 502 stores information for uniquely identifying a group (specifically, a Group identifier (ID)). In the exemplary embodiment, the User ID column 504 stores information for uniquely identifying a user (specifically, a User ID). The remarks column 506 stores remarks (a specific organization name). Using the user management table 500, a user belonging to a group X, and conversely, a group to which a user Y belongs may be extracted.

For example, the first row of the user management table 500 indicates that the Group ID column 502 is “Group_110”, the User ID column 504 is “User_111”, and the remarks column 506 is “company A department 1”; the second row indicates that the Group ID column 502 is “Group_110”, the User ID column 504 is “User_112”, and the remarks column 506 is “company A department 1”; the fourth row indicates that the Group ID column 502 is “Group_120”, the User ID column 504 is “User_121”, and the remarks column 506 is “company A department 2”; the fifth row indicates that the Group ID column 502 is “Group_120”, the User ID column 504 is “User_122”, and the remarks column 506 is “company A department 2”; the seventh row indicates that the Group ID column 502 is “Group_210”, the User ID column 504 is “User_211”, and the remarks column 506 is “company B department 1”; the eighth row indicates that the Group ID column 502 is “Group_210”, the User ID column 504 is “User_212”, and the remarks column 506 is “company B department 1”; and the tenth row indicates that the Group ID column 502 is “Group_999”, the User ID column 504 is “-” (indicating that no user belongs), and the remarks column 506 is “public”.

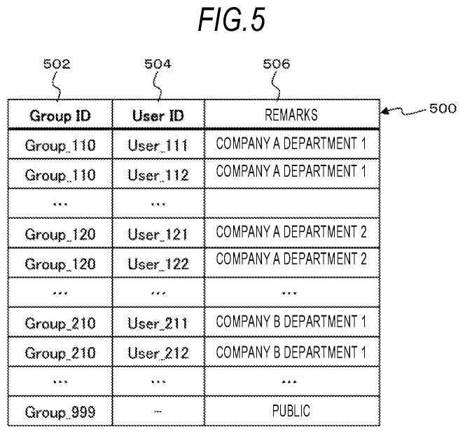

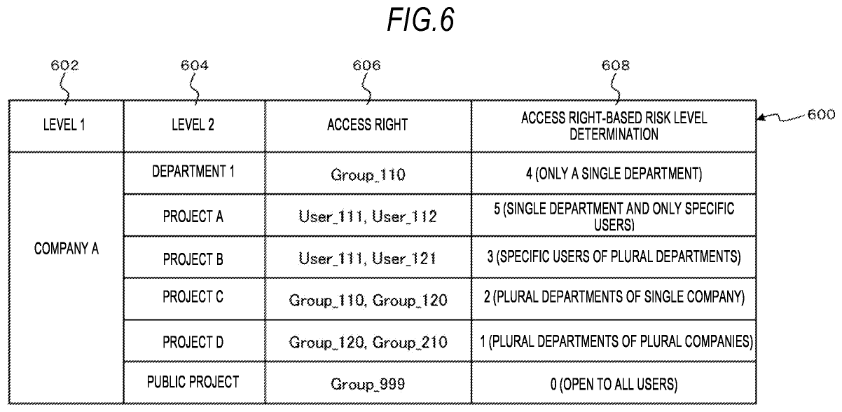

FIG. 6 is a view illustrating an example of a data structure of the risk level determination table 600. The risk level determination table 600 is stored in the document management device 340.

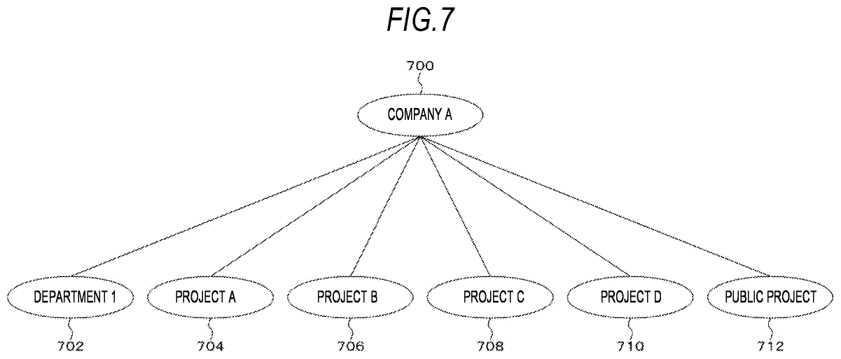

The risk level determination table 600 includes a level 1 column 602, a level 2 column 604, an access right column 606, and the access right-based risk level determination column 608. The level 1 column 602 stores an upper level 1. The level 2 column 604 stores a level 2 below the level 1. The relationship between the level 1 and the level 2 will be described later with reference to an example of FIG. 7. The access right column 606 stores a group or a user having an access right to the folder. The phrase “a group has an access right” refers to that all users belonging to the group have the access right. The access right-based risk level determination column 608 stores an access right-based risk level determination. That is, the access right-based risk level determination column 608 stores a risk level of a document belonging to the folder.

The risk level in the access right-based risk level determination column 608 (that is, the risk level of the document belonging to the folder) has been determined according to the number of organizations to which users having access rights to the document belong. Here, “when people having access rights to the folder are in a single department (the people are users belonging to one department), and are only specified users (that is, when people having access rights are specified by user IDs and the users of the user IDs belong to the same department)”, a “risk level 5” is set. “When people having access rights to the folder are in a single department (that is, when people having access rights are specified by one group ID)”, a “risk level 4” is set. “When people having access rights to the folder are users scattering in plural departments (that is, when people having access rights are specified by user IDs and the users of the user IDs (at least one user) belong to different departments (meanwhile, the departments are in the same company))”, a “risk level 3” is set. “When people having access rights to the folder are in plural departments within a single company (here, a company A) (that is, when people having access rights are specified by group IDs, and the groups of the group IDs belong to the same company (here, the company A))”, a “risk level 2” is set. “When people having access rights to the folder are in departments of plural companies (here, the company A and a company B) (that is, when people having access rights are specified by group IDs, and the groups of the group IDs (at least one group) belong to different companies (here, the company A and the company B))”, a “risk level 1” is set. “When people having access rights to the folder are in a public group (that is, when people having access rights are specified by a group ID and the group of the group ID is a public group)”, a “risk level 0” is set.

In this manner, a risk level of a document has been determined according to the number of organizations to which users having access rights to the document belong. This may be grasped as follows.

(1) The risk level of the document may be determined according to whether users having access rights to the document are specified by user IDs for identifying individuals, or specified by group IDs for identifying groups (sets of plural users). The risk level for the case in which the users are specified by group IDs is lower than that for the case in which the users are specified by user IDs.
(2) The risk level of the document may be determined according to the number of organizations to which users having access rights to the document belong. The larger the number of organizations is, the lower the risk level is.
(3) The risk level of the document may be determined according to the number of users having access rights to the document. The larger the number of users is, the lower the risk level is. When the users are specified by a group ID, the number of users having access rights to the document is the number of users belonging to the group of the group ID.
(4) The risk level of the document may be determined based on contents of the document. For example, the risk level may be determined based on a disclosure range described in the header or the footer of the document, a feature word included in the document, or the like. It is possible to interpolate and strengthen the determination of the risk level based on the access right to the document. It is also possible to deal with an event that a setting of the access right is missing, an error in a storage folder, or the like.

As described above, the “risk level of the document” means that the higher the value of the risk level is, the higher the risk is. That is, the higher the risk level of the document is, the more limited the people who can access the document are. When the risk level of the document is the lowest value (for example, 0), anyone can access the document.

For example, the first row of the risk level determination table 600 indicates that the level 1 column 602 is a “company A” folder, the level 2 column 604 is a “department 1” folder under the “company A” folder, the access right column 606 is “Group_110”, and the access right-based risk level determination column 608 is a “risk level 4 (only a single department)”. The second row indicates that the level 1 column 602 is the “company A” folder, the level 2 column 604 is a “project A” folder under the “company A” folder, the access right column 606 is “User_111, User_112” having an access right to the folder, and the access right-based risk level determination column 608 is a “risk level 5 (a single department and only specific users)”. The third row indicates that the level 1 column 602 is the “company A” folder, the level 2 column 604 is a “project B” folder under the “company A” folder, the access right column 606 is “User_111, User 121” having an access right to the folder, and the access right-based risk level determination column 608 is a “risk level 3 (specific users of plural departments)”. The fourth row indicates that the level 1 column 602 is the “company A” folder, the level 2 column 604 is a “project C” folder under the “company A” folder, the access right column 606 is “Group_110, Group 120” having an access right to the folder, and the access right-based risk level determination column 608 is a “risk level 2 (plural departments of a single company)”. The fifth row indicates that the level 1 column 602 is the “company A” folder, the level 2 column 604 is a “project D” folder under the “company A” folder, the access right column 606 is “Group_120, Group 210” having an access right to the folder, and the access right-based risk level determination column 608 is a “risk level 1 (plural departments of plural companies)”. The sixth row indicates that the level 1 column 602 is the “company A” folder, the level 2 column 604 is a “public project” folder under the “company A” folder, the access right column 606 is “Group_999” having an access right to the folder, and the access right-based risk level determination column 608 is a “risk level 0 (open to all users)”.

FIG. 7 is a view illustrating an example of a hierarchical structure of folders.

Under a company A folder 700, a department 1 folder 702, a project A folder 704, a project B folder 706, a project C folder 708, a project D folder 710, and a public project 712 are present. Then, documents are stored in the department 1 folder 702, the project A folder 704, the project B folder 706, the project C folder 708, the project D folder 710, and the public project 712.

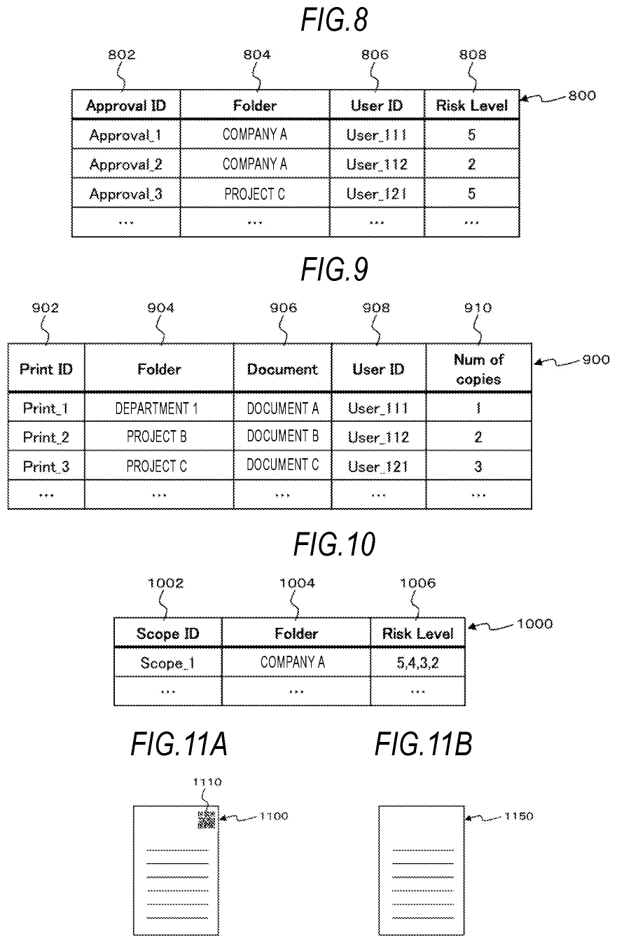

FIG. 8 is a view illustrating an example of a data structure of the pre-approval table 800. The pre-approval table 800 is stored in the taking-of-documents management device 344. The pre-approval table 800 shows results of pre-approval by the approver in step S402 in the flowchart illustrated in the example of FIG. 4.

The pre-approval table 800 includes an Approval ID column 802, a Folder column 804, a User ID column 806, and a Risk Level column 808. The Approval ID column 802 stores information for uniquely identifying an approval in the exemplary embodiment (specifically, an Approval ID). The Folder column 804 stores a folder which is subject to the approval. The User ID column 806 stores a user ID which is subject to the approval. The Risk Level column 808 stores a risk level for a combination of the folder and a user of the user ID.

For example, the first row in FIG. 8 indicates that for the Approval ID: Approval_1, the folder is “company A”, the User ID is “User_111”, and the risk level is “5”. The second row indicates that for the Approval ID: Approval_2, the folder is “company A”, the User ID is “User_112”, and the risk level is “2”. The third row indicates that for the Approval ID: Approval_3, the folder is “project C”, the User ID is “User_121”, and the risk level is “5”.

FIG. 9 is a view illustrating an example of a data structure of the taking-of-documents management table 900. The taking-of-documents management table 900 is stored in the taking-of-documents management device 344.

The taking-of-documents management table 900 includes a Print ID column 902, a Folder column 904, a Document column 906, a User ID column 908, and a Num of copies column 910. The Print ID column 902 stores information for uniquely identifying printing (information for managing taking of a document, specifically, a Print ID) in the exemplary embodiment. The Folder column 904 stores a folder in which a printed document was stored. The Document column 906 stores the printed document. The User ID column 908 stores a user ID of a user who made an instruction about the printing. The Num of copies column 910 stores the number of copies by which the printing was performed.

For example, the first row of the taking-of-documents management table 900 indicates that for the Print ID: Print_1, the folder is “department 1”, the document is “document A”, the User ID is “User_111”, and the number of printed copies is “1”. The second row indicates that for the Print ID: Print_2, the folder is “project B”, the document is “document B”, the User ID is “User_112”, and the number of printed copies is “2”. The third row indicates that for the Print ID: Print_3, the folder is “project C”, the document is “document C”, the User ID is “User_121”, and the number of printed copies is “3”.

FIG. 10 is a view illustrating an example of a data structure of the management scope table 1000. The management scope table 1000 is stored in the taking-of-documents management device 344.

The management scope table 1000 includes a Scope ID column 1002, a Folder column 1004, and a Risk Level column 1006. In the exemplary embodiment, the Scope ID column 1002 stores information for uniquely identifying a management scope (specifically, a Scope ID). The Folder column 1004 stores a target folder. The Risk Level column 1006 stores a risk level indicating a scope within which documents in the folder are treated as objects the taking of which are managed.

For example, the first row of the management scope table 1000 indicates that for the Scope ID: Scope_1, the folder is “company A”, and a risk level is “5, 4, 3, 2”. This indicates that when a user who is permitted to take a document having a risk level of “5, 4, 3, or 2” tries to print the document, the document is printed with addition of an information image embedded with an identification number. This indicates that documents which have a risk level “1 or 0” and which are stored in the “company A” folder are not objects the taking of which are managed, that is, the documents are printable without addition of an information image.

FIGS. 11A and 11B are views illustrating an example of printing according to the exemplary embodiment. FIGS. 11A and 11B illustrate examples of documents printed by the printing device 350.

To a print document 1100 illustrated in the example of FIG. 11A, an identifier image 1110 is added. That is, FIG. 11A illustrates an example in which the print document 1100 which is an object the taking of which is managed is printed, and illustrates an example of printing by processing in step S416 of the flowchart illustrated in the example of FIG. 4.

To a print document 1150 illustrated in the example of FIG. 11B, no information image is added. That is, FIG. 11B illustrates an example in which the print document 1150 that is not an object the taking of which is managed is printed, and illustrates an example of printing by processing in step S418 of the flowchart illustrated in the example of FIG. 4.

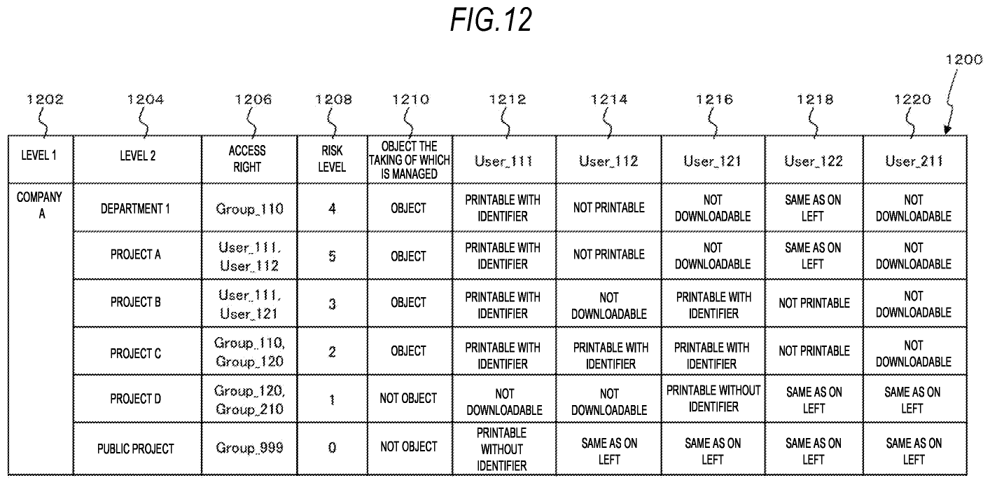

FIG. 12 is a view illustrating an example of processing by the exemplary embodiment (an example of a printability determination result).

A printability determination example 1200 includes a level 1 column 1202, a level 2 column 1204, an access right column 1206, a risk level column 1208, a management object column 1210, a User_111 column 1212, a User_112 column 1214, a User_121 column 1216, a User_122 column 1218, and a User_211 column 1220. The level 1 column 1202 indicates a level 1. The level 2 column 1204 indicates a level 2. The access right column 1206 indicates an access right. The risk level column 1208 indicates a risk level. The management object column 1210 indicates information about whether a document is an object the taking of which is managed. The User_111 column 1212 indicates a User_111. The User_112 column 1214 indicates a User_112. The User_121 column 1216 indicates a User_121. The User_122 column 1218 indicates a User_122. The User_211 column 1220 indicates a User_211.

Assuming that data have been set as illustrated in the examples from FIG. 5 to FIG. 10. FIG. 12 illustrates (i) when each user tries to print a document in each folder at home, whether the document is printable (if the document is not printable, “not downloadable” is described), and (ii) if the document is printable, whether the document falls within the management scope (if the document falls within the management scope, “printable with identifier” is described; and if the document is out of the management scope, “printable without identifier” is described).

The level 1 column 1202 to the risk level column 1208 are contents of the risk level determination table 600 illustrated in the example of FIG. 6. The management object column 1210 illustrates the result when the management scope table 1000 illustrated in the example of FIG. 10 is applied.

For example, the first row of the printability determination example 1200 indicates that the level 1 is “company A”, the level 2 is “department 1”, the access right is “Group_110”, the risk level is “4”, and documents are objects the taking of which are managed. In trying to print a document in the folder at home, the User_111 is “printable with identifier”, the User_112 is “not printable”, the User 121 is “not downloadable”, the User 122 is “not downloadable”, and the User 211 is “not downloadable”.

The second row of the printability determination example 1200 indicates that the level 1 is “company A”, the level 2 is “project A”, the access right is “User_111, User 112”, the risk level is “5”, and documents are objects the taking of which are managed. In trying to print a document in the folder at home, the User_111 is “printable with identifier”, the User_112 is “not printable”, the User 121 is “not downloadable”, the User 122 is “not downloadable”, and the User 211 is “not downloadable”.

The third row of the printability determination example 1200 indicates that the level 1 is “company A”, the level 2 is “project B”, the access right is “User_111, User 121”, the risk level is “3”, and documents are objects the taking of which are managed. In trying to print a document in the folder at home, the User_111 is “printable with identifier”, the User_112 is “not downloadable”, the User_121 is “printable with identifier”, the User_122 is “not printable”, and the User_211 is “not downloadable”.

The fourth row of the printability determination example 1200 indicates that the level 1 is “company A”, the level 2 is “project C”, the access right is “Group_110, Group 120”, the risk level is “2”, and documents are objects the taking of which are managed. In trying to print a document in the folder at home, the User_111 is “printable with identifier”, the User_112 is “printable with identifier”, the User_121 is “printable with identifier”, the User_122 is “not printable”, and the User_211 is “not downloadable”.

The fifth row of the printability determination example 1200 indicates that the level 1 is “company A”, the level 2 is “project D”, the access right is “Group_120, Group 210”, the risk level is “1”, and document are not objects the taking of which are managed. In trying to print a document in the folder at home, the User_111 is “not downloadable”, the User_112 is “not downloadable”, the User_121 is “printable without identifier”, the User_122 is “printable without identifier”, and the User_211 is “printable without identifier”.

The sixth row of the printability determination example 1200 indicates that the level 1 is “company A”, the level 2 is “public project”, the access right is “Group_999”, the risk level is “0”, and documents are not objects the taking of which are managed. In trying to print a document in the folder at home, the User_111 is “printable without identifier”, the User_112 is “printable without identifier”, the User_121 is “printable without identifier”, the User_122 is “printable without identifier”, and the User_211 is “printable without identifier”.

Hereinafter, descriptions will be made on each user. Documents in the public project are documents to which every user has an access right, and are not objects the taking of which are managed.

### (1) User_111

The user 111 belongs to the department 1 of the company A (Group_110) (see the user management table 500).
Up to a risk level 5 in the company A have been pre-approved for the user 111 (see Approval_1 of the pre-approval table 800). Therefore, a document having a risk level equal to or lower than the risk level 5 of the User_111 is printable. It is noted that the User_111 needs to have an access right to the document.
A document printable at home is a “document to which User_111 has an access right, and that satisfies Approval_1 (a document having a risk level of 5 or less)” or a “document to which User_111 has an access right and that is not an object the taking of which is managed”. Specifically, the former corresponds to a document in the department 1, a document in the project A, a document in the project B, and a document in the project C. The latter corresponds to a document in the public project.
Documents having risk levels of 5 to 2 under the company A folder (see Scope_1 of the management scope table 1000) are objects the taking of which are managed. Documents in the project D having a risk level of 1, and documents in the public project having a risk level of 0 are not objects the taking of which are managed (hereinafter, the same is applied).
A recording example in which a document that is an object the taking of which is managed was printed is Print_1 in the taking-of-documents management table 900.

### (2) User_112

The user 112 belongs to the department 1 of the company A (Group_110) (see the user management table 500).
Up to a risk level 2 in the company A has been pre-approved for the User_112 (see Approval_2 of the pre-approval table 800). Therefore, a document having a risk level equal to or lower than the risk level 2 of the User_112 is printable. It is noted that the User_112 needs to have an access right to the document.
A document printable at home is a “document to which the User_112 has an access right and that satisfies Approval_2 (that is, a document having a risk level of 2 or less)” or a “document to which the User_112 has an access right and that is not an object the taking of which is managed”. Specifically, the former corresponds to a document in the project C. The latter corresponds to a document in the public project.
Documents having risk levels of 5 to 2 under the company A folder (see Scope_1 of the management scope table 1000) are objects the taking of which are managed.
A recording example in which a document that is an object the taking of which is managed was printed is Print_2 in the taking-of-documents management table 900.

### (3) User_121

The User_121 belongs to the department 2 of the company A (Group 120) (see the user management table 500).
Up to a risk level 5 in the project C has been pre-approved for the User_121 (see Approval_3 of the pre-approval table 800). Therefore, a document having a risk level equal to or lower than the risk level 5 of the User_121 is printable. It is noted that the User_121 needs to have an access right to the document.
A document printable at home is a “document to which the User_121 has an access right and that satisfies Approval_3 (that is, a document having a risk level of 5 or less)” or a “document to which the User_121 has an access right and that is not an object the taking of which is managed”. Specifically, the former corresponds to a document in the project B, a document in the project C, and a document in the project D. The latter corresponds to a document in the public project.
Documents having risk levels of 5 to 2 under the company A folder (see Scope_1 of the management scope table 1000) are objects the taking of which are managed.
A recording example in which a document that is an object the taking of which is managed was printed is Print_3 in the taking-of-documents management table 900.

### (4) User_122

The User_122 belongs to the department 2 of the company A (Group 120) (see the user management table 500).
No pre-approval has been made for the User_122 (see the pre-approval table 800).
A document printable at home is a document to which the User_122 has an access right and that is not an object the taking of which is managed. Specifically, the document corresponds to a document in the project D and a document in the public project.

### (5) User_211

The User_211 belongs to the department 1 of the company B (Group 210) (see the user management table 500).
No pre-approval has been made for the User_211 (see the pre-approval table 800).
A document printable at home is a document to which the User_211 has an access right and that is not an object the taking of which is managed. Specifically, the document corresponds to a document in the project D and a document in the public project.

In the exemplary embodiment, when a user whose risk level has not been set in the pre-approval table 800 tries to print a document that is determined to be not printable, the printing operation may be suspended, and a notification may be given to an approver. After the approver sets a risk level, a print mode may be determined, and printing instructed by the printing operation may be permitted. The application procedure by the user becomes unnecessary, and it is allowed for the user to print (take out) the document without cancelling the printing operation. Of course, even after the approver sets the risk level, printing may not be permitted depending on the risk level set for the target user.

In the comparison process in the description of the above-described exemplary embodiment, “equal to or greater than”, “equal to or less than”, “greater than”, and “less than” are examples, and may be “greater than”, “less than”, “equal to or greater than”, and “equal to or less than”, respectively, unless a contradiction occurs in the combination.

In the embodiments above, the term “processor” refers to hardware in a broad sense. Examples of the processor include general processors (for example, CPU: Central Processing Unit) and dedicated processors (for example, GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Meanwhile, the described program may be provided while being stored in a recording medium, or the program may be provided via a communication unit. In such a case, for example, the above-described program may be regarded as an invention of a “computer-readable recording medium having a program recorded therein”.

The “computer-readable recording medium having a program recorded therein” refers to a computer-readable recording medium having a program recorded therein, which is used for installing, executing, and distributing the program.

Meanwhile, examples of the recording medium may include a digital versatile disc (DVD), for example, “DVD-R, DVD-RW, DVD-RAM, etc.” which are standards established in a DVD forum, and “DVD+R, DVD+RW, etc.” which are standards established in DVD+RW, a compact disc (CD), for example, a read-only memory (CD-ROM), a CD recordable (CD-R), a CD rewritable (CD-RW), etc., a Blu-ray (registered trademark) disc, a magneto-optical disc (MO), a flexible disc (FD), a magnetic tape, a hard disk, a read-only memory (ROM), an electrically erasable programmable read only memory (EEPROM (registered trademark)), a flash memory, a random access memory (RAM), a secure digital (SD) memory card and the like.

Then, the whole or a part of the above program may be stored or distributed while being recorded in the above recording medium. The program may be transmitted through a communication, for example, using a wired network, or a wireless communication network used for a local area network (LAN), a metropolitan area network (MAN), a wide area network (WAN), the Internet, an intranet, an extranet and the like, or using a transmission medium having a combination of these. Also, the program may be carried on a carrier wave.

Further, the above program may be a part or the whole of another program, or may be recorded in a recording medium together with a separate program. The program may be dividedly recorded in plural recording media. The program may be recorded in any manner such as compression or encryption as long as the program can be restorable.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
receive information about a printing device instructed by a user to print a document;
when the information about the printing device is information about a printing device other than a predetermined printing device, acquire information about an access right of the user to the document; and
determine a print mode of the document according to the information about the access right.

2. The information processing apparatus according to claim 1, wherein
a risk level has been set for the document according to the access right assigned to the document,
a risk level for which the user has been approved in advance has been set for the user, and
the processor is configured to compare the risk level of the document to the risk level of the user to determine the print mode of the document.

3. The information processing apparatus according to claim 2, wherein
the risk level of the document has been determined according to the number of organizations to which users having access rights to the document belong, and
the processor is configured to determine the print mode of the document when the risk level of the document is equal to or less than the risk level of the user.

4. The information processing apparatus according to claim 2, wherein
the risk level of the document has been determined according to whether users having access rights to the document are specified persons, and
the processor is configured to determine the print mode of the document when the risk level of the document is equal to or less than the risk level of the user.

5. The information processing apparatus according to claim 1, wherein
a risk level has been set for the document according to the access right assigned to the document, and
the processor is further configured to determine the print mode according to the risk level of the document.

6. The information processing apparatus according to claim 5, wherein
the print mode has been determined for each of folders according to the risk level, and
the processor is configured to, when the risk level of the document is included in the risk levels determined for a folder to which the document belongs, print information indicating that the document has been taken out of an organization to which the user belongs, on the document as print mode.

7. The information processing apparatus according to claim 1, wherein
the predetermined printing device is specified based on information for identifying the printing device, a location where the printing device is provided, or a communication line to which the printing device is connected, and
the processor is configured to, when the printing device that tries to print the document is not the predetermined printing device, perform processing of determining the print mode of the document.

8. An information processing method comprising:
receiving information about a printing device instructed by a user to print a document;
when the information about the printing device is information about a printing device other than a predetermined printing device, acquiring information about an access right of the user to the document; and
determining a print mode of the document according to the information about the access right.

9. A non-transitory computer readable medium storing a program that causes a computer to execute information processing, the information processing comprising:
receiving information about a printing device instructed by a user to print a document;
when the information about the printing device is information about a printing device other than a predetermined printing device, acquiring information about an access right of the user to the document; and
determining a print mode of the document according to the information about the access right.
